(19) United States
(12) Patent Application Publication
(10) Pub. No.: US 2012/0098322 A1
(43) Pub. Date: Apr. 26, 2012

(54) SEAT FRAME DEVICE

(75) Inventor: Kurt Müller, Ravensburg (DE)

(73) Assignee: RECARO AIRCRAFT SEATING GMBH & CO. KG, Schwäbisch Hall (DE)

(21) Appl. No.: 13/259,487

(22) PCT Filed: Mar. 24, 2010
(86) PCT No.: PCT/EP2010/001851

§ 371 Date: Nov. 28, 2011

(30) Foreign Application Priority Data
Mar. 27, 2009 (DE) 10 2009 014 721.7

(51) Int. Cl. B60N 2/68; B32B 37/12

(52) U.S. Cl. 297/452.18; 156/60

(57) ABSTRACT

A seat frame device for having at least two frame parts which are connected by way of at least one connection. At least one connection is formed at least partially of a pin connection, having at least one pin which is secured in the respective connection position by way of a safety connection.

### CROSS REFERENCE TO RELATED APPLICATIONS

This application is a U.S. national stage application of PCT/EP2010/001851 filed on Mar. 24, 2010, and claims priority to, and incorporates by reference, German patent application No. 10 2009 014 721.7 filed on Mar. 27, 2009.

### BACKGROUND

Seat frame devices for aircraft seats, which have frame parts connected via a screw connection, are already known.

### SUMMARY

The invention is based on a seat frame device, in particular a seat frame device for a means of transportation, comprising at least two frame parts connected via at least one connection.

It is proposed that the at least one connection is formed at least partially by a pin connection comprising at least one pin secured in its connection position by means of a securing connection. “Seat frame device for a means of transportation” is intended to be understood, in particular, as a device provided to be used in a means of transportation such as a vehicle, a ship and/or particularly advantageously in an aircraft. “Frame part” is intended to be understood, in particular, as a part of a frame, which is provided to transmit the weight force of a person seated on a seat comprising the seat frame device and/or to transmit acceleration forces caused by the act of transportation and acting on the person, to a floor of a means of transportation, in particular to a floor of an aircraft. Herein the seat legs serve, in particular, for transmitting forces to a floor, such as in particular an aircraft floor, and seat dividers serve, in particular, for supporting a backrest. “Securing connection” is intended to be understood as, in particular, a connection which is provided to hold the pin exclusively in its connection position and, in the longitudinal direction of the pin, to absorb forces up to a maximum of 100 N and preferably a maximum of 50 N, and/or “pin connection which is formed by at least one pin secured in its connection position by means of a securing connection” is intended, in particular, to be understood as a pin connection which is effected by means of at least one headless pin. In this case “headless” is intended to be understood, in particular, as meaning that the pin does not have a head at either end, i.e. a region at one end of a pin which, proceeding from a longitudinal center axis, has, relative to a cross section of a region adjacent thereto, a greater transverse extension in each transverse axis and, viewed in the longitudinal direction from a central region in the direction of the head, has a projection in the region of the head which has an angle of less than 130° and preferably less than 135°, and, in particular, does not have a screw head nor a rivet head. By a corresponding embodiment weight may be saved in turn. Particularly advantageously, the pin connection constitutes a principal connection which is provided, i.e. in particular is specifically designed, to absorb at least a substantial part i.e. preferably at least 10%, preferably at least 30% and particularly preferably at least 50% of at least one weight force and/or acceleration force occurring during operation, which acts in a direction of the frame parts, which without the pin connection would lead to a movement of the frame parts relative to one another.

In a further embodiment of the invention, it is proposed that the securing connection is effected by means of a shaping process, whereby this connection may be implemented in terms of construction in a simple and cost-effective manner.

An advantageous dismountability may be ensured if the securing connection is effected by means of a shaping process of the pin.

Moreover, a seat frame device, in particular a seat frame device for a means of transportation is proposed, comprising at least two frame parts connected via at least one adhesive bond, wherein at least one of the frame parts is at least one part of a seat divider and/or seat leg comprising at least one adhesive surface. In this case, “adhesive bond” is intended to be understood, in particular, as a connection effected by means of an adhesive, the adhesive being provided to hold together components to be connected by an adhesive force. Even though the adhesive bond can constitute only one securing connection of a fastening means, which is provided to hold a fastening part, such as in particular a screw, in its fastened position, yet the adhesive bond particularly advantageously constitutes a principal connection which is provided, i.e. in particular is specifically designed, to absorb at least a substantial part, i.e. preferably at least 10%, preferably at least 30% and particularly preferably at least 50% of at least one weight force and/or acceleration force occurring during operation, which acts in one direction of the frame parts and which, without the adhesive bond, would lead to a movement of the frame parts relative to one another. By an appropriate design, components, mounting effort, cost and in particular weight may be saved, which is particularly advantageous, in particular, for an aircraft seat frame device.

Preferably, at least one of the frame parts forms at least partially a cross member element which comprises at least one adhesive surface of the adhesive bond. A “cross member element” is intended to be understood, in particular, as an element which is provided to connect, in a mounted state, a plurality of seat legs and/or seat dividers, in particular of a plurality of seats arranged adjacent to one another, transversely with respect to a seating direction, i.e. transversely with respect to the viewing direction of a person sitting upright on a seat comprising the seat frame device, the person's head being in an unrotated position, and which is connected to a plurality of seat legs. By means of a corresponding embodiment a high potential for saving weight may, in particular, be realized.

The cross member element may be formed from different components appearing as expedient to a person skilled in the art, but particularly advantageously at least partially from a hollow profile, whereby a particularly lightweight and stable device may be achieved by a particularly simple design. The hollow profile may thus have different cross-sectional shapes appearing as expedient to the person skilled in the art, such as for example angular, oval and/or particularly advantageously round.

The cross member element may also advantageously be constructed from a single beam. “Single beam” is intended to be understood in this context as, in particular, a component which is solely provided to connect seat legs and/or seat dividers in a transverse direction and/or transversely with respect to the seating direction and, in particular, is provided to absorb torques so that, in the seating direction, a cross member element spaced apart from the single beam may be avoided. By a corresponding embodiment, weight and in particular constructional space may be saved in turn. In particular, it is also advantageous to bond together parts of the single beam and/or to bond the single beam to adjacent components.

In a further embodiment of the invention, it is proposed that at least one of the frame parts comprises a shell-shaped adhesive surface. In this case, “shell-shaped surface” is intended to be understood as, in particular, a concave, preferably curved surface. By a corresponding embodiment, an advantageously large adhesive surface and an advantageous introduction of force may be achieved.

Preferably, the adhesive bond comprises an adhesive surface which is wider than at least one supporting part of the seat divider and/or the seat leg. In this case, “width” is intended to be understood, in particular, as an extension transversely with respect to the seating direction, in particular parallel to a seat front edge. By a corresponding embodiment, an advantageous force distribution may be achieved and namely, in particular, if the adhesive surface is at least double the width of the supporting part, in particular a main supporting part of the seat divider and/or the seat leg, via which at least one main load is transmitted.

The adhesive bond may be effected by means of different adhesives appearing as expedient to the person skilled in the art. Particularly advantageously, however, the adhesive bond is effected by means of a multi-component adhesive, and namely particularly preferably by means of an adhesive based on an epoxy resin, whereby a particularly secure, permanent connection may be achieved.

If the seat frame device comprises at least one pin connection which is provided for securing the adhesive bond, during a bonding process slipping may be advantageously prevented and/or at least individual adhesive regions may be advantageously held together in a form-fit and/or force-fit manner in addition to a material bond. “Pin connection” is intended to be understood as any connection in which a pin-shaped component, such as a screw, a rivet etc. is used for fastening and, in particular, at least partially penetrates at least one of the components to be connected and preferably both components to be connected.

Moreover, weight may be saved and, in particular, an advantageous adhesive bond may be achieved if at least one of the frame parts is formed at least partially from an aluminum-lithium compound.

If the seat frame device has at least one pin connection comprising at least one pin which is held in its connection position by means of a material bond, an advantageous connection of low weight may be effected. In this case, the material bond may be effected by means of an adhesive bond and/or by means of a welding process.

It is also proposed that at least one of the frame parts is directly connected to a first frame part via at least one adhesive bond and is directly connected to at least one second frame part via a second connection which is formed at least partially by a pin connection comprising at least one pin secured in its connection position by means of a securing connection, whereby an advantageous connection may be implemented.

### BRIEF DESCRIPTION OF THE DRAWINGS

Further advantages are revealed by the following description of the drawings. In the drawings, exemplary embodiments of the invention are shown. The description and the claims contain numerous features in combination. The person skilled in the art will also expediently consider the features individually and combine them to form further expedient combinations.

FIG. 1 is a seat frame device obliquely from above,

FIG. 2 is a first enlarged detail of the seat frame device of FIG. 1,

FIG. 3 is a second enlarged detail of the seat frame device of FIG. 1,

FIG. 4 is an enlarged detail of a pin connection of the seat frame device of FIG. 1,

FIG. 5 is an enlarged detail of an alternative pin connection,

FIG. 6 is a pin with a head in the longitudinal direction of the pin for the purposes of illustration, and

FIG. 7 is the pin of FIG. 6 in a side view.

### DETAILED DESCRIPTION OF THE PREFERRED EMBODIMENTS

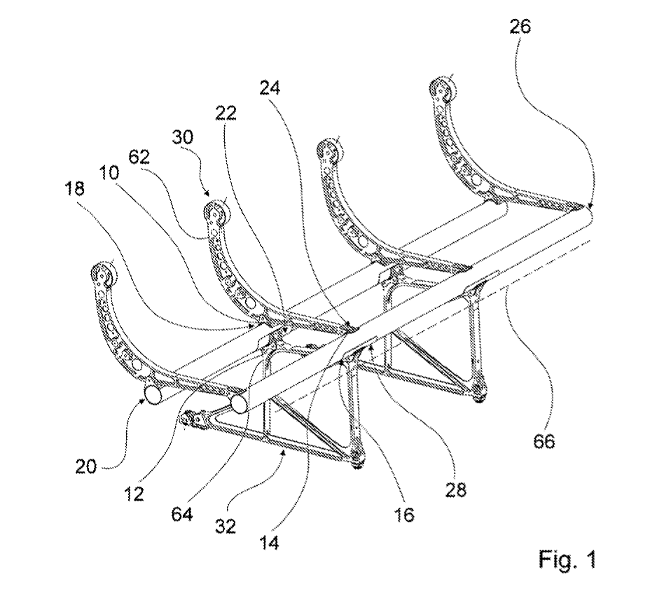

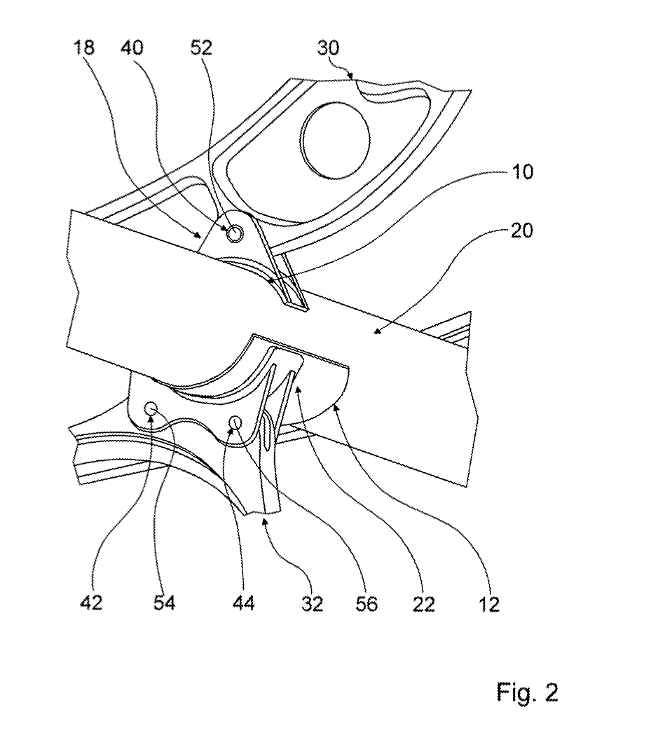

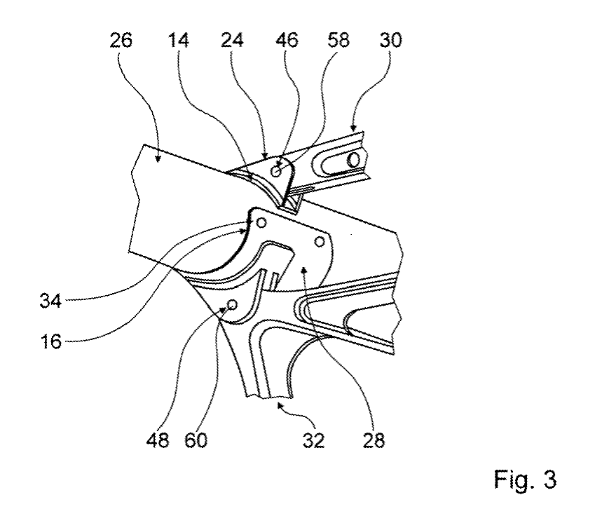

FIG. 1 shows a seat frame device obliquely from above, which is an aircraft seat frame device. The seat frame device has frame parts 18-28 connected via adhesive bonds 10-16, wherein the frame parts 18, 22, 24, 28 in each case are part of a seat divider 30 and/or a seat leg 32 comprising an adhesive surface. The seat frame device is provided for three seats and comprises two seat legs 32 and four seat dividers 30 as well as two frame parts 20, 26, each frame part 20, 26 forming a cross member element and comprising adhesive surfaces of the adhesive bonds 10-16 (FIGS. 2 and 3). The adhesive bonds 10-16 are effected by means of a multi-component adhesive and namely by means of an adhesive based on an epoxy resin. The seat dividers 30 are in each case fastened by an adhesive bond 10 to the frame part 20 forming a cross member element and in each case by an adhesive bond 14 to the frame part 26 forming a cross member element. The seat dividers 30 are supported by the cross member elements. The cross member elements are formed by hollow profiles, and namely by tubes with round cross-sections, and run parallel to a schematically indicated seat front edge 66 of the three seats. The rear cross member element remote from the seat front edge 66 and/or the frame part 20 is in each case connected to the seat legs 32 via an adhesive bond 12, and the front cross member element facing the seat front edge 66 and/or the frame part 26 is also connected in each case to the seat legs 32 via an adhesive bond 16. The cross member elements and/or the frame parts 20, 26 are supported by the seat legs 32. The adhesive bond 16 is secured by means of a pin connection 34, and namely in order to achieve advantageous positioning of the components to be bonded together in a bonding process, and in order to avoid detachment in the edge region. The remaining adhesive bonds 10-14 could also be provided with a corresponding pin connection.

The frame parts 18, 24 are formed by fastening parts of the seat dividers 30, and the frame parts 22, 28 are formed by fastening parts of the seat legs 32. The frame parts 18, 22, 24, 28 in each case have concave, shell-shaped adhesive surfaces which have a radius which corresponds to an outer radius of the cross member elements, so that the adhesive surfaces may be advantageously coupled over their entire surface with the cross member elements. The concave shell-shaped adhesive surfaces of the fastening parts are wider than frame parts 62 of the seat dividers 30 forming main supporting parts, and are wider than frame parts 64 of the seat legs 32 forming main supporting parts. In particular, the adhesive surfaces of the frame parts 28 forming the fastening parts of the seat legs 32 are more than double the width of the main supporting part of the seat leg 32.

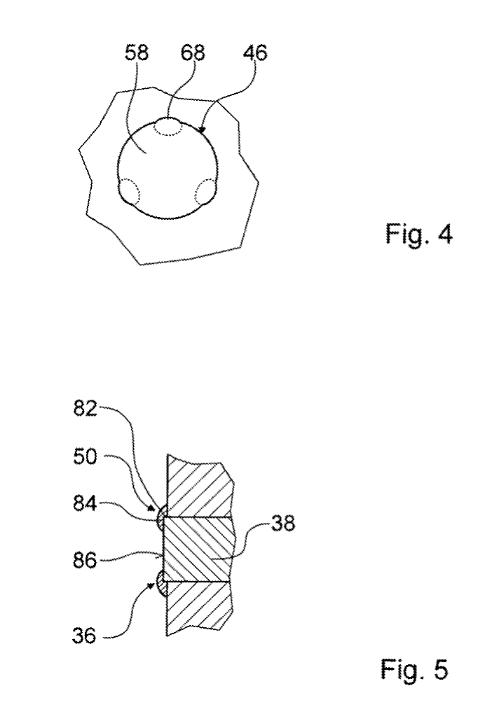

The frame parts 18, 24 of the seat dividers 30, which are formed by fastening parts, have in each case a U-shaped receiver region into which the frame parts 62 of the seat dividers 30 are inserted and fastened by means of connections 40, 46 formed by means of pin connections. The frame parts 22, 28 of the seat legs 32, which are formed by fastening parts, also have in each case a U-shaped receiver region into which the frame parts 64 of the seat legs 32 are inserted and are fastened by connections 42, 44, 48 formed by means of pin connections. The connections 40-48 in each case have a headless pin 52-60 which is secured in its connection position by means of a securing connection. The securing connections are in each case effected by means of a shaping process of the pin 52-60 (FIG. 4) and namely the pins 52-60 are stamped in partial regions 68 at their ends so that in each case, in a radial direction in the partial regions 68, said pins protrude over an edge of a recess of the frame parts 18, 22, 24, 28, through which recess the pins 52-60 have been pushed in order to effect the connections 40-48 before the stamping process.

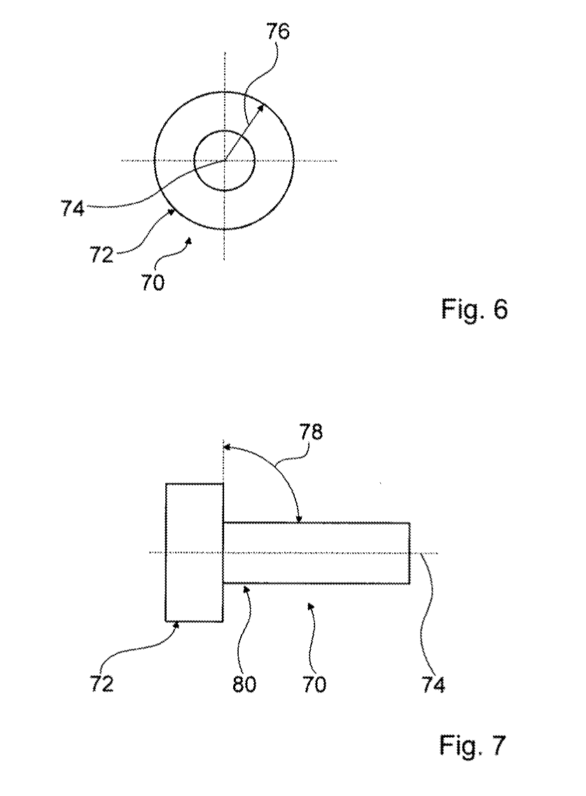

For illustrating a practical definition of the term “headless”, FIGS. 6 and 7 show a pin 70 having a head 72, i.e. having at an end of pin 70 a region which, proceeding from a longitudinal center axis 74, has in each horizontal axis a horizontal extension 76 greater than a cross section of a region 80 adjacent to the head 72, and which has, viewed in a longitudinal direction from a middle region toward the head 72, a projection in the region of the head 72 and/or the head 72 forms a projection having an angle of less than 130° and preferably less than 135°, e.g. an angle 78 of approximately 90° shown in FIG. 7.

Alternatively and/or additionally, pin connections 36 could also be provided which have at least one pin 38, which is held in its connection position by means of a material bond 82, as is shown in FIG. 5 in a connection 50 implemented as a pin connection. The material bond 82 is effected by means of adhesive areas. Herein an adhesive 84 used is arranged on a front face 86 of the pin 38.

1. A seat frame device, in particular a seat frame device for a means of transportation, comprising at least two frame parts connected via at least one connection wherein the at least one connection is formed at least partially by a pin connection comprising at least one pin, which is secured in its connection position by means of a securing connection.

2. The seat frame device as claimed in claim 1, wherein the pin is configured to be headless.

3. The seat frame device as claimed in claim 1, wherein the securing connection is effected by means of a shaping process.

4. The seat frame device as claimed in claim 3, wherein the securing connection is effected by means of a shaping process of the pin.

5. The seat frame device, in particular a seat frame device for a means of transportation, as claimed in claim 1, comprising at least two frame parts connected via at least one adhesive bond, wherein at least one of the frame parts is at least one part of a seat divider and/or seat leg, comprising at least one adhesive surface.

6. The seat frame device as claimed in claim 5, wherein at least one of the frame parts forms at least partially a cross member element which comprises at least one adhesive surface of the adhesive bond.

7. The seat frame device as claimed in claim 5, wherein at least one of the frame parts comprises a shell-shaped adhesive surface.

8. The seat frame device as claimed in claim 5, wherein the adhesive bond comprises an adhesive surface which is wider than at least one supporting part of the seat divider and/or the seat leg.

9. The seat frame device as claimed in claim 5, wherein the adhesive bond is effected by means of a multi-component adhesive.

10. The seat frame device as claimed in claim 5, wherein the adhesive bond is effected by means of an adhesive based on an epoxy resin.

11. The seat frame device as claimed in claim 5, further comprising at least one pin connection which is provided for securing the adhesive bond.

12. The seat frame device as claimed in claim 1, wherein at least one of the frame parts is formed at least partially from an aluminum-lithium compound.

13. The seat frame device as claimed in claim 1, further comprising at least one pin connection comprising at least one pin which is held in its connection position by means of a material bond.

14. The seat frame device at least as claimed in claim 1, wherein at least one of the frame parts is directly connected to a first frame part via at least one adhesive bond, and is directly connected to at least one second frame part via a second connection which is formed at least partially by a pin connection comprising at least one pin which is secured in its connection position by means of a securing connection.

15. A method for manufacturing a seat frame device, as claimed in claim 5, wherein at least one part of a seat divider and/or a part of a seat leg is bonded to a frame part.
